(19) United States
(12) Patent Application Publication
(10) Pub. No.: US 2008/0120354 A1
(43) Pub. Date: May 22, 2008

(54) Electronic device having file listing function and method thereof

(75) Inventor: Young-min Kim, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/896,683

(22) Filed: Sep. 5, 2007

(30) Foreign Application Priority Data
Nov. 21, 2006 (KR) 2006-115314

(51) Int. Cl. G06F 12/06

(52) U.S. Cl. 707/205; 707/E17.031

(57) ABSTRACT

An electronic device comprising a file listing function and a method thereof are provided. The electronic device includes a recording medium for storing a file of a specified format, and a control unit for creating a file path for accessing the file using a code in which a first figure section for constituting a folder name of a folder including the file and a second figure section for constituting a file name of the file are combined. Accordingly, the capacity of file listing is minimized to improve the performance of the electronic device.

### CROSS-REFERENCE TO RELATED APPLICATIONS

This application claims the benefit under 35 U.S.C. §119(a) of Korean Patent Application No. 2006-115314, filed Nov. 21, 2006, in the Korean Intellectual Property Office, the entire disclosure of which is hereby incorporated by reference.

### BACKGROUND OF THE INVENTION

1. Field of the Invention

The present invention relates to an electronic device comprising a file listing function and a method thereof. More particularly, the present invention relates to a file listing method for an image capturing device that captures and records an image.

2. Description of the Related Art

Generally, an image capturing device such as a camera or a camcorder uses a file list stored in an internal or external memory in order to retrieve files stored in a recording medium. That is, by creating a file path using the file list, the image capturing device can access the file selected by a user. The file has a structure according to the design rule for the camera file system (DFC) standard, and as illustrated in FIG. 1, it is stored in the recording medium together with a directory entry from which file information such as the name and size of the file may be known.

FIG. 1 is a view illustrating the directory entry structure of a general file.

Referring to FIG. 1, a file or folder name is recorded in addresses 0 to 8 of the directory entry, and a file extension is stored in addresses 9 to 11. A file or folder attribute is recorded in an address 12, and addresses 13 to 22 refer to a reserved region which may be not in use, or in which other information may be recorded as needed.

Time is recorded in addresses 23 to 24, date is recorded in addresses 25 and 26, and a start cluster of a file is recorded in addresses 27 and 28. A cluster is a logical unit in which one or more sectors are gathered, and a data region for storing the file or folder is divided into a plurality of clusters. Finally, the size of a file or folder is recorded in addresses 29 to 32 of the directory entry.

When the power of the image capturing device is turned on or the recording medium in which the file is stored is mounted on the image capturing device, the image capturing device creates a file list through the directory entry as illustrated in FIG. 1.

FIG. 2 is a flowchart illustrating a file listing method.

Referring to FIG. 2, the image capturing device reads the directory entry from the recording medium in which specified files are stored at step (S10), and then judges whether the attribute recorded in address 12 of the directory entry is the attribute corresponding to a folder at step (S20). If the recorded attribute is the attribute corresponding to the folder, the image capturing device performs the listing of folder names at step (S30). If the recorded attribute is not the attribute corresponding to the folder, it reads the next directory entry at step (S10).

If the listing of the folders is completed through the steps (S10 to S30), the image capturing device reads the directory entry again at step (S40), and then judges whether the attribute recorded in address 12 of the directory entry is the attribute corresponding to a file at step (S50).

If the recorded attribute is the attribute corresponding to the file, the image capturing device performs the listing of file names at step (S60). If the recorded attribute is not the attribute corresponding to the file, it reads the next directory entry.

The created file list, which is in the form as illustrated in Table 1 below, is stored in the image capturing device. The combination of folder names and file names obtained from the file list as stored above, results in the creation of a file path such as “D:\\DCIM\100SSDVC\DCAM0001.jpg”.

TABLE 1

100SSDVC
101SSDVC
.
.
.
999SSDVC
DCAM0001.jpg
DCAM0002.jpg
.
.
.
DCAM9999.jpg

The file list requires a large storage space, and this results in limited system implementation of the image capturing device that uses a relatively small recording medium. Also, as the capacity of a file to be recorded becomes larger and the development of compression technology is expanded, the storage space occupied by the file list also becomes larger, and this causes the system implementation to be more limited.

Accordingly, there is a need for an improved electronic device comprising a file listing function and a method which can remove the limitations in system implementation by minimizing the capacity of a file list.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an electronic device that has a file listing function and a method thereof, which can remove the limitations in system implementation by minimizing the capacity of a file list.

Another aspect of exemplary embodiments of the present invention is to provide an electronic device that has a file listing function and a method thereof, which can create a file path for a user to quickly access a desired file by using a file list with a minimized capacity.

In order to achieve the above-described aspects of exemplary embodiments of the present invention, an electronic device which comprises a recording medium and a control unit is provided. The recording medium stores a file of a specified format and the control unit creates a file path to access the file using a code in which a first figure section for constituting a folder name of a folder including the file and a second figure section for constituting a file name of the file are combined.

The control unit may create the code by storing the first figure section in addresses 0 to 2 of the code and storing the second figure section in addresses 3 to 6 of the code.

The code may further include a reserved region.

The control unit may create the file path by adding a first character section for constituting the folder name to the first figure section and adding a second character section for constituting the file name to the second figure section.

The electronic device, according to exemplary embodiments of the present invention, may further comprise an image capturing unit and an image signal processing unit. The image capturing unit performs photoelectric conversion of an optical image formed through a lens into an electric signal and processes the converted electric signal to create an image signal. The image signal processing unit compresses the image signal created by the image capturing unit into the file of the specified format, wherein the control unit stores the file in the recording medium.

In order to achieve the above-described aspects of exemplary embodiments of the present invention, a file listing method is provided. A file compressed into a specified format is stored and a code is created by combining a first figure section for constituting a folder name of a folder including the file and a second figure section for constituting a file name of the file.

The file listing method, according to exemplary embodiments of the present invention, may further comprise creating a file path for accessing the file by using the code.

The code creating step may create the code by storing the first figure section in addresses 0 to 2 of the code and storing the second figure section in addresses 3 to 6 of the code.

The code may further include a reserved region.

The file listing method, according to exemplary embodiments of the present invention, may further comprise performing photoelectric conversion of an optical image formed through a lens into an electric signal and processing the converted electric signal to create an image signal, and compressing the created image signal into the file of the specified format.

The file path creating step may create the file path by adding a first character section for constituting the folder name to the first figure section and by adding a second character section for constituting the file name to the second figure section.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary objects, features and advantages of certain exemplary embodiments of the present invention will be more apparent from the following description taken in conjunction with the accompanying drawing, in which;

FIG. 1 is a view illustrating the directory entry structure of a general file;

FIG. 2 is a flowchart illustrating a conventional file listing method;

FIG. 3 is a block diagram schematically illustrating the construction of an electronic device according to an exemplary embodiment of the present invention;

FIG. 4 is a view explaining a file listing method according to an exemplary embodiment of the present invention;

FIG. 5 is a flowchart illustrating a file listing method according to an exemplary embodiment of the present invention; and

FIG. 6 is a flowchart explaining a file accessing process in accordance with the file listing method according to an exemplary embodiment of the present invention.

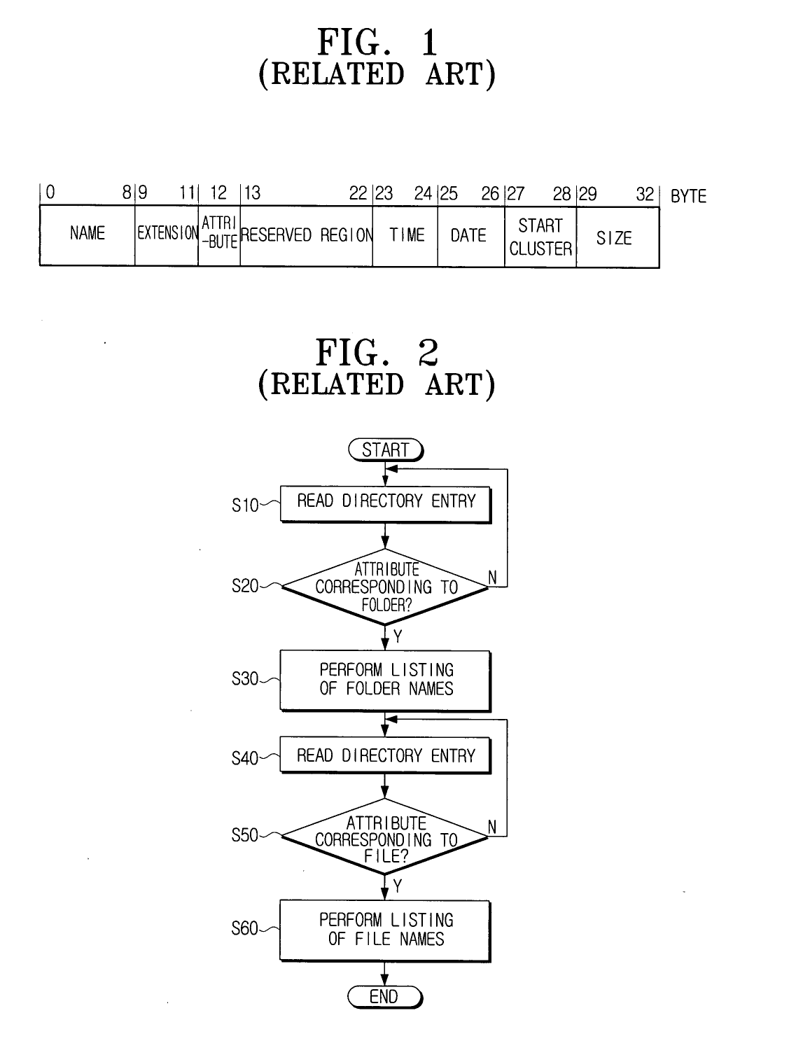

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

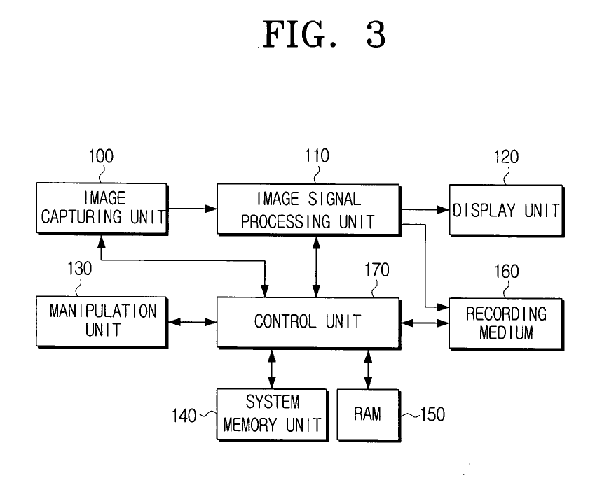

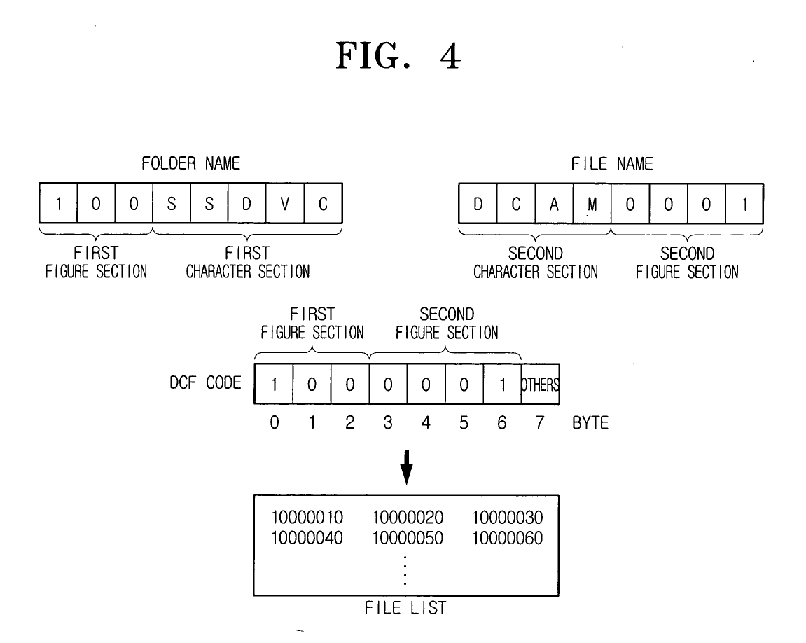

FIG. 3 is a block diagram schematically illustrating the construction of an electronic device according to an exemplary embodiment of the present invention.

Referring to FIG. 3, an image capturing device is illustrated as the electronic device according to an exemplary embodiment of the present invention. The image capturing device comprises an image capturing unit 100, an image signal processing unit 110, a display unit 120, a manipulation unit 130, a system memory unit 140, a RAM (Random Access Memory) 150, a recording medium 160, and a control unit 170.

The image capturing unit 100 performs photoelectric conversion of an optical image incident through a lens (not illustrated) into an electric signal through a charge coupled device (CCD) (not illustrated), and processes the converted electric signal in accordance with conditions such as auto exposure (AE), auto focus (AF), auto white balance (AWB), among others, to produce an image signal. The image capturing unit 100 also performs digital signal processing of the produced image signal.

The image signal processing unit 110 processes the digital image signal output from the image capturing unit 100 to display the image signal through the display unit 120, or compresses the image signal into a file of a JPEG or MPEG format.

The manipulation unit 130 comprises various types of keys for inputting a user's commands. The manipulation unit 130 receives a variety of commands for controlling the operation of the image capturing device from a user, and transfers corresponding signals to the control unit 170.

In the system memory unit 140, program sources required to perform the operation of the image capturing device and setting information set by the user are stored. The program sources or the setting information stored in the system memory unit 140 are preferably not erased even if the power of the image capturing device is turned off.

In the RAM 150, data generated while the control unit 170 controls the operation of the image capturing device is temporarily stored. The data stored in the RAM 150 is erased when the power of the image capturing device is turned off.

In the recording medium 160, a file compressed through the image signal processing unit 110 is stored. A memory card, a NAND flash memory, an optical recording medium such as a digital versatile disk (DVD), or a hard disk drive (HDD) may be used as the recording medium 160. The memory card may be a secure digital (SD) card, a multimedia card (MMC), a memory stick, a compact flash (CF) card, or a smart media (SM) card. The memory card comprises a NAND flash card. In the recording medium 160, a directory entry that includes a file name, a folder name including the file, an attribute, a date, and so forth, is stored together with the file.

The control unit 170 creates a file list of files stored in the recording medium 160, and then quickly accesses the files stored in the recording medium 160 using the file list. That is, the control unit 170 creates a design rule for camera file system (DCF) code using the DCF standard. Then, the control unit creates a file path using the DCF code, and accesses the files through the file path.

For example, if a specified file is created through the image signal processing unit 110, the control unit 170 verifies whether a “DCIM” folder that is a root folder exists. If the root folder does not exist, the control unit 170 creates the root folder, and then creates a “100SSDVC” folder that is a lower folder of the root folder. Then, the control unit 170 stores the file created through the image signal processing unit 110 in the “100SSDVC” folder with a file name of “DCAM0001.jpg”. The control unit 170 stores following files of “DCAM0002.jpg” to “DCAM9999.jpg” created through the image signal processing unit 110 in the “100SSDVC” folder, and then creates a “101SSDVD” folder. Lower folders can be further created in the order of“101SSDVC” to “999SSDVC”.

As described above, according to the DCF standard, the folder name includes three figures and five characters, and the file name includes four characters and four figures. The control unit 170 creates the DCF code by extracting three figures from the folder name and extracting four figures from the file name. The creation of the DCF codes by the control unit is directly proportional to the number of files stored in the recording medium 160. The control unit also stores the created DCF codes in the form of a file list. This file list may be stored in the system memory unit 140, the RAM 150, and the recording medium 160 in accordance with the user's selection.

FIG. 4 is an illustration of a file listing method according to an exemplary embodiment of the present invention.

Referring to FIG. 4, the folder name is composed of a first figure section in the range of “100” to “999”, and a first character section expressed as an ASCII code in the range of “0” to “9” and “A” to “Z”. Also, the file name is composed of a second figure section in the range of “0001” to “9999”, and a second character section expressed as an ASCII code in the range of “0” to “9” and “A” to “Z”. According to an exemplary implementation, since the first character section and the second character section are fixed to characters prescribed by the manufacturer of the image capturing device, the control unit 170 creates the DCF code by extracting only the first figure section from the folder name and extracting only the second figure section from the file name.

The DCF code includes 8 bytes. The first figure section is recorded in addresses or bytes 0 to 2, the second figure section is recorded in addresses or bytes 3 to 6, and the reserved region which is reserved to store other data therein is recorded in address 7. The DCF codes are created in direct proportion to the number of files created in the image capturing device, and the created DCF codes are stored in the file list as shown in FIG. 4.

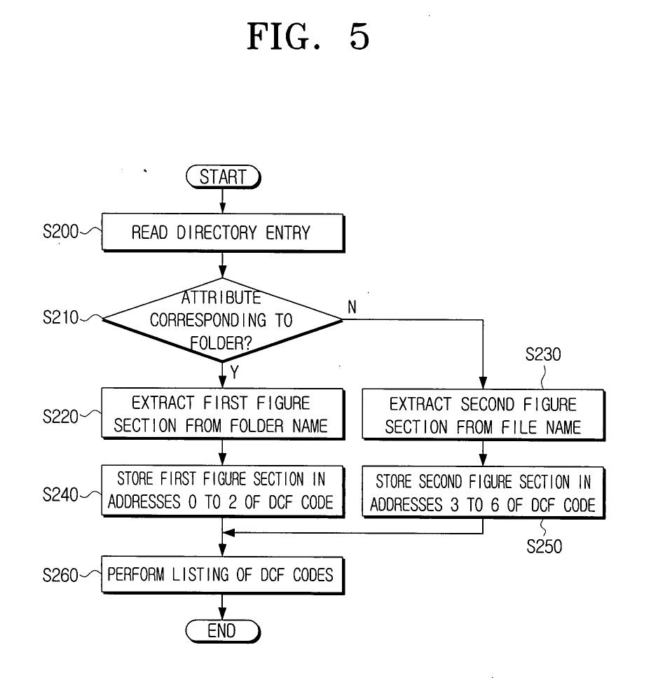

FIG. 5 is a flowchart illustrating a file listing method according to an exemplary embodiment of the present invention.

Referring to FIG. 5, the control unit 170 reads the directory entry from the recording medium 160 in which files are stored at step (S200), and determines whether the attribute of the directory entry is the attribute corresponding to the folder at step (S210). If a determination has been made that the attribute of the directory entry is the attribute corresponding to the folder, the control unit 170 extracts the first figure section from the folder name of the directory entry at step (S220), and stores the extracted first figure section in addresses or bytes 0 to 2 of the DCF code at step (S240).

By contrast, if a determination has been made that the attribute of the directory entry is not the attribute corresponding to the folder, but is the attribute corresponding to the file, the control unit 170 extracts the second figure section from the file name of the directory entry at step (S230), and stores the extracted second figure section in addresses or bytes 3 to 6 of the DCF code at step (S250). Then, the control unit 170 creates the file list by listing the created DCF codes at step (S260).

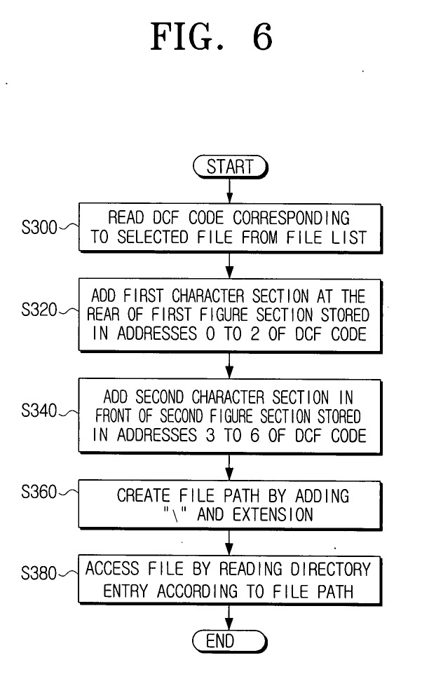

FIG. 6 is a flowchart explaining a file accessing process in accordance with the file listing method according to an exemplary embodiment of the present invention.

Referring to FIG. 6, the control unit 170 reads the DCF code that corresponds to the file selected by the user from the file list at step (S300). Then, the control unit 170 adds the first character section to the end of the first figure section stored in addresses 0 to 2 of the DCF code at step (S320), and adds the second character section to the beginning of the second figure section stored in addresses 3 to 6 of the DCF code at step (S340). Finally, the control unit 170 creates a file path by adding and extension at step (S360). Then, the control unit 170 accesses the file by reading the directory entry recorded in the recording medium 160 along the created file path at step (S380).

Through the above-described processes as illustrated in FIGS. 5 and 6, the file list is created, and then the file is accessed using the created file list. The file listing method as described above may be used in all electronic devices with recording mediums, in addition to the image capturing device as illustrated in FIG. 3.

As described above, according to an exemplary embodiment of the present invention, the capacity of the file list is minimized, and thus the system limitations caused by the reduction of the memory capacity of the electronic device may be reduced. Also, since the file path for quickly accessing the file desired by the user is created, the performance of the electronic device may be improved.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An electronic device comprising:
a recording medium for storing a file of a specified format; and
a control unit for creating a file path for accessing the file using a code in which a first figure section for constituting a folder name of a folder including the file and a second figure section for constituting a file name of the file are combined.

2. The electronic device of claim 1, wherein the code comprises plural bytes having respective addresses, and wherein the control unit creates the code by storing the first figure section in a first subset of the addresses of the code and storing the second figure section in another subset of the addresses of the code.

3. The electronic device of claim 1, wherein the code further comprises a reserved region.

4. The electronic device of claim 1, wherein the control unit creates the file path by adding a first character section for constituting the folder name to the first figure section, and by adding a second character section for constituting the file name to the second figure section.

5. The electronic device of claim 1, further comprising:
an image capturing unit for performing photoelectric conversion of an optical image formed through a lens into an electric signal and processing the converted electric signal to create an image signal; and
an image signal processing unit for compressing the image signal created by the image capturing unit into the file of the specified format;
wherein the control unit stores the file in the recording medium.

6. A file listing method comprising:
storing a file compressed into a specified format; and
creating a code by combining a first figure section for constituting a folder name of a folder including the file and a second figure section for constituting a file name of the file.

7. The file listing method of claim 6, further comprising creating a file path for accessing the file by using the code.

8. The file listing method of claim 6, wherein the code comprises plural bytes having respective addresses and creating a code comprises creating the code by storing the first figure section in a first subset of the addresses of the code and storing the second figure section in a second subset of the addresses of the code.

9. The file listing method of claim 6, wherein the code further comprises a reserved region.

10. The file listing method of claim 6, further comprising:
performing photoelectric conversion of an optical image formed through a lens into an electric signal and processing the converted electric signal to create an image signal; and
compressing the created image signal into the file of the specified format.

11. The file listing method of claim 7, wherein creating the file path comprises creating the file path by adding a first character section for constituting the folder name to the first figure section and by adding a second character section for constituting the file name to the second figure section.
